(19) United States
(12) Patent Application Publication
(10) Pub. No.: US 2025/0178110 A1
(43) Pub. Date: Jun. 5, 2025

(54) ENHANCED SOLDER PASTE DISPENSING TOOL AND METHOD

(71) Applicant: Intel Corporation, Santa Clara, CA (US)

(72) Inventor: Thanh Tan NGUYEN, Ho-Chi-Minh City (VN)

(21) Appl. No.: 18/528,820

(22) Filed: Dec. 5, 2023

(51) Int. Cl. B23K 3/06

(52) U.S. Cl. CPC B23K 3/0638

(57) ABSTRACT

A solder paste cartridge is disclosed that includes a body with a connection arm and a chamber, which has a front wall with a first angled bottom panel and a back wall with a second angled bottom panel that form an unpartitioned space. In an aspect, a first lower edge of the first angled bottom panel and a second lower edge of the second angled bottom panel form an aperture for the chamber. In another aspect, a pushing member may be positioned between the front and back walls of the chamber and may have a first angled bottom surface and a second angled bottom surface. The pushing member may move from an upper position to a lower position in the chamber, which positions the first and second angled bottom surfaces of the pushing member approximal to the first and second angled bottom panels of the chamber.

### BACKGROUND

For integrated circuit design and fabrication, the need to improve performance and lower costs are constant challenges. Surface mount technology (SMT) is an important process whereby semiconductor components are mounted onto the surface of a printed circuit board (PCB). The majority of semiconductor components are designed specifically to be directly mounted, rather than hardwired, onto the PCB for the vast majority of electronic appliances. One of the most important parts of the surface mounting assembly process is the application of solder paste to the PCB. This process step requires an accurate deposition of a correct amount of solder paste onto each of the pads to be soldered.

The solder paste deposition is typically performed by screen-printing the solder paste through a stencil or foil using a solder paste dispensing tool. If the application of the solder paste is not properly controlled, there are likely to be assembly defects that will reduce yields. Examples of defects include having an insufficient or excess amount of solder on a location, having paste solder paste dispensed outside a pad area that forms solder balls between two component leads resulting in a bridge or short circuit, false or incomplete soldering, etc. There are numerous variables that may affect the transfer efficiency of a solder paste from a solder paste dispensing or printing tool to the stencil and the PCB. In addition, it is desirable to avoid and/or reduce the wastage of solder paste material when using a solder paste printing tool.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 shows an exemplary representation of a solder paste dispensing tool with a perspective view of a present solder paste cartridge according to an aspect of the present disclosure;

FIG. 2 shows an exemplary representation of a side view of a present solder paste cartridge according to an aspect of the present disclosure;

FIG. 3 shows an exemplary representation of a bottom perspective view of a present solder paste cartridge according to an aspect of the present disclosure;

FIGS. 4A and 4B show exemplary representations of cross-sectional views of components of a present solder paste cartridge according to an aspect of the present disclosure;

FIG. 5 shows an exemplary representation of another cross-sectional view of a present solder paste cartridge according to an aspect of the present disclosure;

FIG. 6 shows an exemplary representation of a present solder paste cartridge assembly according to another aspect of the present disclosure; and

FIG. 7 shows a simplified flow diagram for an exemplary method according to an aspect of the present disclosure.

### DETAILED DESCRIPTION

The following detailed description refers to the accompanying drawings that show, by way of illustration, specific details, and aspects in which the present disclosure may be practiced. These aspects are described in sufficient detail to enable those skilled in the art to practice the present disclosure. Various aspects are provided for devices, and various aspects are provided for methods. It will be understood that the basic properties of the devices also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

According to the present disclosure, a present solder paste cartridge/dispenser is designed to permit the unimpeded flow of solder paste and reduces the amount of unused or wasted solder paste material in the solder paste cartridge. The present solder paste cartridge may have a body with an unpartitioned chamber that permits a pushing member to move unimpeded within the chamber. The chamber holds the solder paste material and has a lower portion that is shaped similarly to a lower portion of the pushing member. The lower portion of the body also has first and second angled bottom panels, which have first and second lower edges, respectively, that act as squeegees or knife edges to provide transfer efficiency.

The present disclosure provides a solder paste cartridge that includes a body with a connection arm and a chamber. In an aspect, the chamber has a front wall with a first angled bottom panel and a back wall with a second angled bottom panel that form an unpartitioned space. In another aspect, an aperture is formed between a first lower edge of the first angled bottom panel and a second lower edge of the second angled bottom panel. In another aspect, a pushing member may be positioned between the front and back walls of the chamber and may have a first angled bottom surface and a second angled bottom surface. The pushing member may move from an upper position to a lower position in the chamber and disposes the first and second angled bottom surfaces of the pushing member proximally to the first and second angled bottom panels of the chamber.

The present disclosure is also directed to a method that includes providing a solder paste printing/dispensing tool with a movable solder paste cartridge, for which the movable solder paste cartridge has a chamber with a front wall with a first angled bottom panel and a back wall with a second angled bottom panel. In this aspect, the chamber contains a solder paste material and has a pushing member positioned between the front and back walls of the chamber. The pushing member includes a first angled bottom surface and a second angled bottom surface that pushes the solder paste material in the chamber of the movable solder paste cartridge, which is dispensed onto a substrate with a stencil that is placed in the solder paste printing tool. The movable solder paste cartridge sweeps over the substrate and the solder paste material is dispensed by driving the pushing member from an upper position to a lower position in the chamber to dispose the first and second angled bottom surfaces of the pushing member proximal to the first and second angled bottom panels of the chamber.

The present disclosure is further directed to a solder paste printing tool having a movable solder paste cartridge that includes a chamber including a front wall with a first angled bottom panel and a back wall with a second angled bottom panel. The chamber contains a solder paste material and a pushing member positioned between the front and back walls of the chamber. The pushing member includes a first angled bottom surface and a second angled bottom surface, moves from an upper position to a lower position in the chamber, and disposes the first and second angled bottom surfaces of the pushing member between the first and second angled bottom panels of the chamber. As the movable solder paste cartridge travels across a surface of a substrate, the solder paste material is dispensed onto the substrate.

The technical advantages of the present disclosure include, but are not limited to:
(i) providing a solder paste cartridge with a chamber and a pushing member design that reduces wastage of solder paste material by permitting the pushing member to move unimpeded within the chamber and dispense approximately 85 percent of a solder paste material held in the chamber;
(ii) providing a solder paste cartridge design with lower edge squeegees/knives that are positioned to improve transfer efficiency; and
(iii) providing a solder paste cartridge with a chamber design that reduces the formation of bubbles in a solder paste material held within the chamber.

To more readily understand and put into practical effect the present solder paste cartridge and tool, as well as the methods for their use, which may provide improved soldering efficiency, particular aspects will now be described by way of examples provided in the drawings that are not intended as limitations. The advantages and features of the aspects herein disclosed will be apparent through reference to the following descriptions relating to the accompanying drawings. Furthermore, it is to be understood that the features of the various aspects described herein are not mutually exclusive and can exist in various combinations and permutations. For the sake of brevity, duplicate descriptions of features and properties may be omitted.

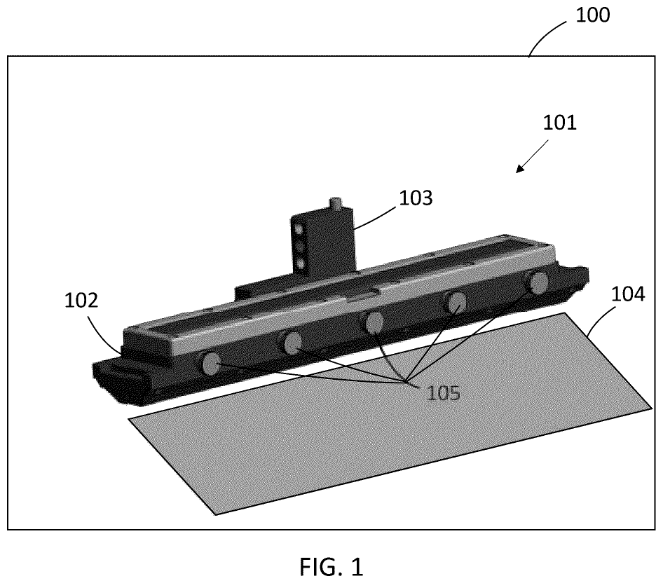

FIG. 1 shows an exemplary representation of a solder paste printing/dispensing tool 100 with a perspective view of a present solder paste cartridge 101 according to an aspect of the present disclosure. The solder paste cartridge 101 may be used by the solder paste printing tool 100 to hold and dispense solder paste material onto a substrate 104. The solder paste cartridge 101 may include a body 102 and a connection arm 103, which may be attached to a movable frame (not shown). In another aspect, the body 102 may have a plurality of inlets that are covered by knobs 105. A solder paste material may be placed into a chamber (shown below) in the body 102 by injecting the solder paste material into the plurality of inlets in a sequential order, which may reduce the introduction of bubbles inside the chamber.

In an aspect, a solder paste material may be a powdered solder suspended in a thick medium called flux. The flux acts as a temporary adhesive, holding the components in place until the soldering process melts the solder and forms the electrical/mechanical connection. In addition, the solder paste material may be a thixotropic material that requires energy to be applied in the form of a print head motion for it to change viscosity and flow evenly into the stencil apertures. The solder paste material may be selected based on the sizes of the apertures in a stencil.

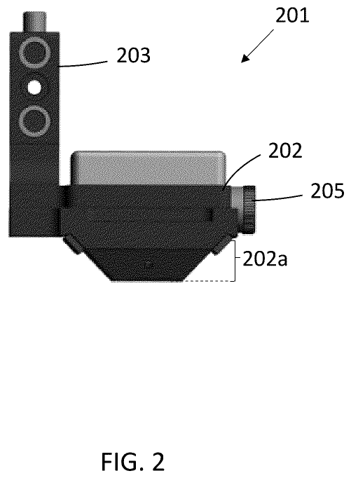

FIG. 2 shows an exemplary representation of a side view of a present solder paste cartridge according to an aspect of the present disclosure. A solder paste cartridge 201 may have a body 202, which has a tapered bottom section 202a. Also, in FIG. 2, a connection arm 203 and a knob 205 are components of the solder paste cartridge 201.

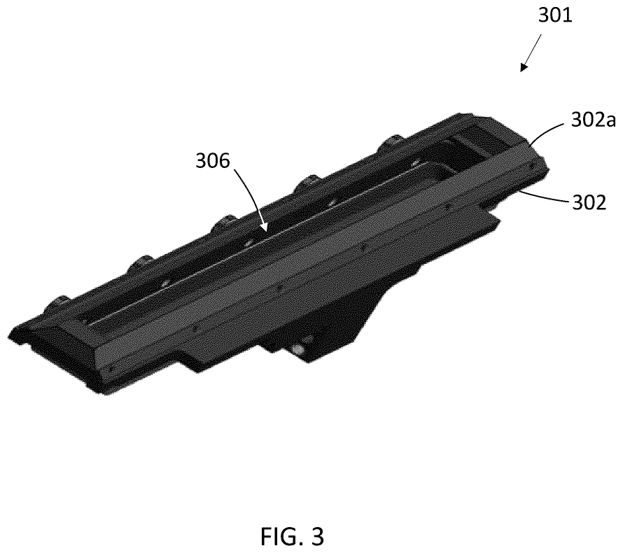

FIG. 3 shows an exemplary representation of a bottom perspective view of a present solder paste cartridge according to an aspect of the present disclosure. A solder paste cartridge 301 may have a body 302, which has a tapered bottom section 302a. As shown in FIG. 3, the tapered bottom section 302a may have an aperture 306, which permits a solder paste material to be dispersed from the solder paste cartridge 301.

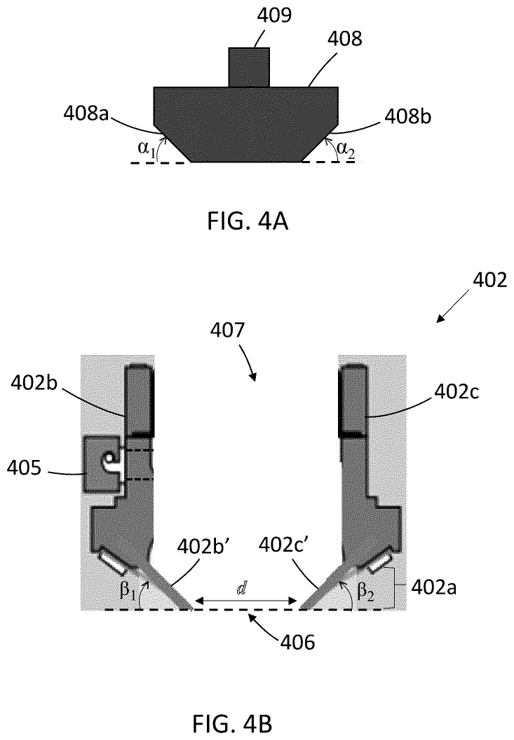

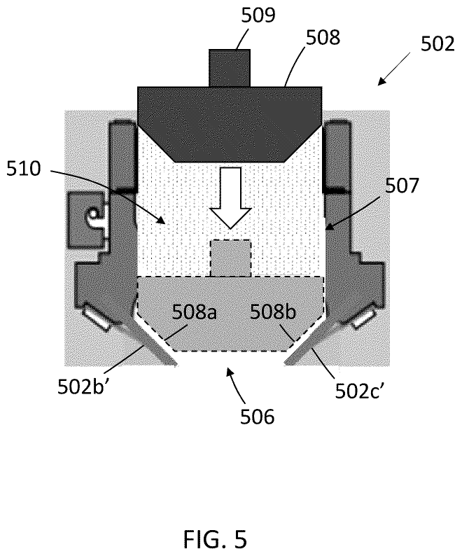

FIGS. 4A and 4B show exemplary representations of cross-sectional views of components of a present solder paste cartridge according to an aspect of the present disclosure. A present solder paste cartridge may have a body 402 with a chamber 407 and a pushing member 408, which may be positioned inside the chamber, as shown in FIG. 5 below.

The pushing member 408 may, for example, be a piston plunger, which may be a trapezoid-shaped block as shown in FIG. 4A, or an accordion plunger, which may have a pressurized baffle, or a shell plunger, which may be a rigid-shaped plate, that moves a solder paste material through the chamber 407. The pushing member 408 may have a first angled bottom surface 408a and a second angled bottom surface 408b. In an aspect, the first angled bottom surface 408a and the second angled bottom surface of the pushing member 408b may be disposed at angles α₁ and α₂, respectively, of approximately 45 degrees with a bottom horizontal. In another aspect, the first and second angled bottom surfaces may have angles α₁ and α₂ in a range of approximately 30 to 45 degrees.

In another aspect, the pushing member 408 may have a single or dual cylinder or other drive mechanism 409, which may include a motor, a pulley system, or a pressure system (not shown). A digital sensor (not shown) may be incorporated into the drive mechanism to detect a dispensing end-stroke position in the chamber 407, which will stop the drive mechanism.

As shown in FIG. 4B, the body 402 may have a front wall 402b with a first angled bottom panel 402b′ and a back wall 402c with a second angled bottom panel 402c′. In an aspect, the first angled bottom panel 402b′ and the second angled bottom panel 402c′ may form a tapered section 402a of the body 402 and be disposed at angles β₁ and β₂, respectively, of approximately 45 degrees with a bottom horizontal. In another aspect, the first and second angled bottom panels may have angles β₁ and β₂, in a range of approximately 30 to 45 degrees. The first and second angled bottom panels 402b′ and 402c″, respectively, may have first and second lower edges that act as squeegees or knife edges to provide transfer efficiency. In another aspect, the first and second edges may be separately attached plastic squeegees or steel knife blades.

In another aspect, a first angled bottom surface and a second angled bottom surface of a pushing member may have shapes that are generally complimentary with a first angled bottom panel and a second angled bottom panel, respectively, of the chamber. Accordingly, angles α₁ and α₂, respectively, may be approximately the same as angles β₁ and β₂.

In another aspect, an aperture 406 may be formed between a first lower edge of the first angled bottom panel 402b′ and a second lower edge of the second angled bottom panel 402c′ that may have a width d in a range of approximately 20 to 30 mm. In particular, the aperture 406 may have a width d of approximately 26 mm.

FIG. 5 shows an exemplary representation of another cross-sectional view of a present solder paste cartridge according to an aspect of the present disclosure. A present solder paste cartridge may have a body 502 with a chamber 507 and a pushing member 508, which may be positioned inside the chamber and have a piston 509. As shown in FIG. 5, the pushing member 508 may be advanced by the piston 509 from an upper position to a lower position in the chamber 507 and a solder paste material 510 may be dispensed from an aperture 506. In an aspect, the pushing member 508 extrudes approximately 85 to 90 percent of the solder paste material 510 from the chamber 507.

In an aspect, the pushing member 508 may stop advancing when a first and second angled bottom surfaces of the pushing member 508a and 508b, respectively, are proximal to a first and second angled bottom panels 502b′ and 502c′ of the chamber 507.

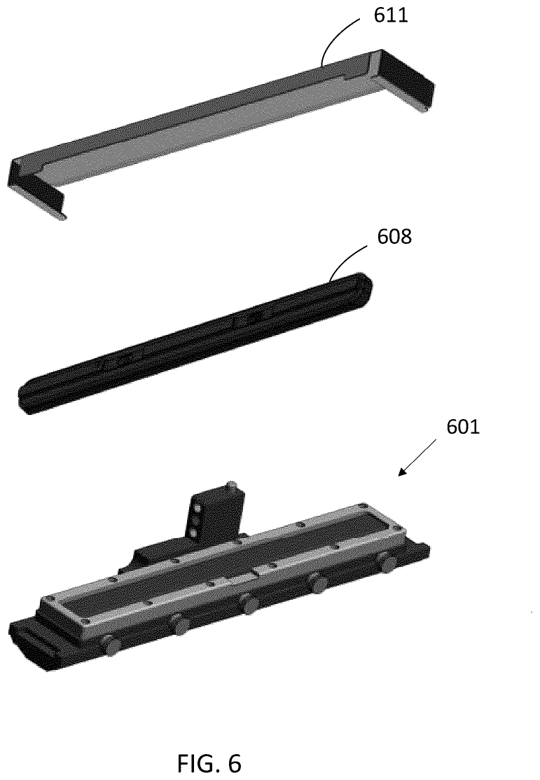

FIG. 6 shows an exemplary representation of a present solder paste cartridge assembly according to another aspect of the present disclosure. In this aspect, a solder paste cartridge 601 may have a pushing member 608 and a top cover 611 that may be used when the solder paste cartridge is being stored or the solder paste printing tool is not operating.

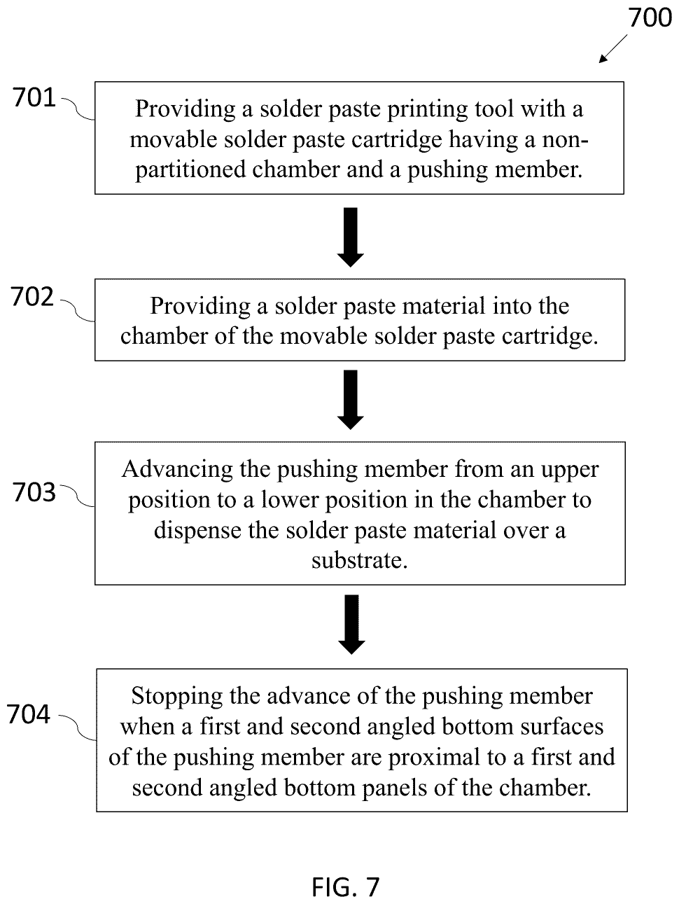

FIG. 7 shows a simplified flow diagram for an exemplary method 700 according to an aspect of the present disclosure.

The operation 701 may be directed to providing a solder paste printing tool with a movable solder paste cartridge having an unpartitioned chamber and a pushing member.

The operation 702 may be directed to providing a solder paste material into the chamber of the movable solder paste cartridge.

The operation 703 may be directed to advancing the pushing member from an upper position to a lower position in the chamber to dispense the solder paste material over a substrate.

The operation 704 may be directed to stopping the advance of the pushing member when a first and second angled bottom surfaces of the pushing member are proximal to a first and second angled bottom panels of the chamber.

It will be understood that any property described herein for a particular solder paste cartridge and method for dispensing solder paste material may also hold for any solder paste cartridge using the present design described herein. It will also be understood that any property described herein for a specific method may hold for any of the methods described herein. Furthermore, it will be understood that for any solder paste cartridge and the methods described herein, not necessarily all the components or operations described will be shown in the accompanying drawings or method, but only some (not all) components or operations may be disclosed.

To more readily understand and put into practical effect the present solder paste cartridge used in a solder dispensing tool, they will now be described by way of examples. For the sake of brevity, duplicate descriptions of features and properties may be omitted.

### Examples

Example 1 provides a solder paste cartridge including a body with a connection arm and a chamber, the chamber including a front wall with a first angled bottom panel and a back wall with a second angled bottom panel, whereby an aperture is formed between a first lower edge of the first angled bottom panel and a second lower edge of the second angled bottom panel, and a pushing member positioned between the front and back walls of the chamber, the pushing member including a first angled bottom surface and a second angled bottom surface, for which the pushing member is configured to move from an upper position to a lower position in the chamber and disposes the first and second angled bottom surfaces of the pushing member approximal to the first and second angled bottom panels of the chamber.

Example 2 may include the solder paste cartridge of example 1 and/or any other example disclosed herein, for which the first and second angled bottom surfaces of the pushing member have shapes that are complimentary with the first and second angled bottom panels of the chamber.

Example 3 may include the solder paste cartridge of example 2 and/or any other example disclosed herein, for which the first angled bottom panel and the second angled bottom panel of the chamber are disposed at angles of approximately 45 degrees from a bottom horizontal.

Example 4 may include the solder paste cartridge of example 2 and/or any other example disclosed herein, for which the first angled bottom surface and the second angled bottom surface of the pushing member are disposed at angles of approximately 45 degrees from a bottom horizontal.

Example 5 may include the solder paste cartridge of example 1 and/or any other example disclosed herein, for which the aperture formed between the first lower edge of the first angled bottom panel and the second lower edge of the second angled bottom panel has a width in a range of approximately 20 to 30 mm.

Example 6 may include the solder paste cartridge of example 5 and/or any other example disclosed herein, for which the aperture formed between the first lower edge of the first angled bottom panel and the second lower edge of the second angled bottom panel has a width of approximately 26 mm.

Example 7 may include the solder paste cartridge of example 1 and/or any other example disclosed herein, for which the pushing member includes a plunger and piston to dispense a solder paste material from the chamber.

Example 8 may include the solder paste cartridge of example 7 and/or any other example disclosed herein, for which the pushing member extrudes approximately 85 percent of the solder paste material from the chamber.

Example 9 provides a method that includes providing a solder paste printing tool with a movable solder paste cartridge, for which the movable solder paste cartridge includes a chamber with a front wall with a first angled bottom panel and a back wall with a second angled bottom panel, for which the chamber contains a solder paste material, a pushing member positioned between the front and back walls of the chamber, for which the pushing member includes a first angled bottom surface and a second angled bottom surface, providing a solder paste material into the chamber of the movable solder paste cartridge, disposing a substrate with a stencil into the solder paste printing tool, and conveying the movable solder paste cartridge over the substrate and dispensing the solder paste material by advancing the pushing member from an upper position to a lower position in the chamber to position the first and second angled bottom surfaces of the pushing member proximal to the first and second angled bottom panels of the chamber.

Example 10 may include the method of example 9 and/or any other example disclosed herein, further including the first angled bottom panel of the chamber having a first lower edge and the second angled bottom panel of the chamber having a second lower edge and moving the dispensed solder paste material over the stencil and substrate using the first and second lower edges, respectively, of the first and second angled bottom panels of the chamber.

Example 11 may include the method of example 10 and/or any other example disclosed herein, for which the first angled bottom panel and the second angled bottom panel of the chamber are disposed at angles of approximately 45 degrees from a bottom horizontal.

Example 12 may include the method of example 9 and/or any other example disclosed herein, for which the movable solder paste cartridge dispenses approximately 85 percent of the solder paste material onto the substrate.

Example 13 may include the method of example 9 and/or any other example disclosed herein, further including the front wall of the chamber having a plurality of inlets, and providing a solder paste material into the chamber by introducing the solder paste material into the plurality of inlets in a sequential order.

Example 14 provides a solder paste printing tool including a movable solder paste cartridge that includes an unpartitioned chamber including a front wall with a first angled bottom panel and a back wall with a second angled bottom panel, for which the chamber contains a solder paste material, a pushing member positioned between the front and back walls of the chamber, the pushing member including a first angled bottom surface and a second angled bottom surface, and for which the pushing member moves from an upper position to a lower position in the chamber and disposes the first and second angled bottom surfaces of the pushing member proximal to the first and second angled bottom panels of the chamber, and for which the movable solder paste cartridge travels across a surface of a substrate to dispense the solder paste material onto the substrate.

Example 15 may include the solder paste printing tool of example 14 and/or any other example disclosed herein, for which the first and second angled bottom surfaces of the pushing member have shapes that are complimentary with the first and second angled bottom panels of the chamber.

Example 16 may include the solder paste printing tool of example 15 and/or any other example disclosed herein, for which the first angled bottom panel and the second angled bottom panel of the chamber form diagonals of approximately 45 degrees from a bottom horizontal.

Example 17 may include the solder paste printing tool of example 15 and/or any other example disclosed herein, for which the first angled bottom surface and the second angled bottom surface of the pushing member form diagonals of approximately 45 degrees from a bottom horizontal.

Example 18 may include the solder paste printing tool of example 14 and/or any other example disclosed herein, further including the first angled bottom panel of the chamber having a first lower edge and the second angled bottom panel of the chamber having a second lower edge, for which an aperture is formed between the first lower edge of the first angled bottom panel and the second lower edge of the second angled bottom panel.

Example 19 may include the solder paste printing tool of example 18 and/or any other example disclosed herein, for which the aperture has a width of approximately 26 mm.

Example 20 may include the solder paste printing tool of example 14 and/or any other example disclosed herein, for which the movable solder paste cartridge dispenses approximately 85 percent of the solder paste material onto the substrate.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

The terms “and” and “or” herein may be understood to mean “and/or” as including either or both of two stated possibilities.

While the present disclosure has been particularly shown and described with reference to specific aspects, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

What is claimed is:

1. A solder paste cartridge comprising:
a body comprising a connection arm and a chamber, the chamber comprising:
a front wall with a first angled bottom panel;
a back wall with a second angled bottom panel, wherein an aperture is formed between a first lower edge of the first angled bottom panel and a second lower edge of the second angled bottom panel; and
a pushing member positioned between the front wall and the back wall of the chamber, the pushing member comprising a first angled bottom surface and a second angled bottom surface,
wherein the pushing member is configured to move from an upper position to a lower position in the chamber and disposes the first and second angled bottom surfaces of the pushing member approximal to the first and second angled bottom panels of the chamber.

2. The solder paste cartridge of claim 1, wherein the first and second angled bottom surfaces of the pushing member have shapes that are complimentary with the first and second angled bottom panels of the chamber.

3. The solder paste cartridge of claim 2, wherein the first angled bottom panel and the second angled bottom panel of the chamber are disposed at angles of approximately 45 degrees from a bottom horizontal.

4. The solder paste cartridge of claim 2, wherein the first angled bottom surface and the second angled bottom surface of the pushing member are disposed at angles of approximately 45 degrees from a bottom horizontal.

5. The solder paste cartridge of claim 1, wherein the aperture formed between the first lower edge of the first angled bottom panel and the second lower edge of the second angled bottom panel has a width in a range of approximately 20 to 30 mm.

6. The solder paste cartridge of claim 5, wherein the aperture formed between the first lower edge of the first angled bottom panel and the second lower edge of the second angled bottom panel has a width of approximately 26 mm.

7. The solder paste cartridge of claim 1, wherein the pushing member comprising a plunger and piston to dispense a solder paste material from the chamber.

8. The solder paste cartridge of claim 7, wherein the pushing member extrudes approximately 85 percent of the solder paste material from the chamber.

9. A method comprising:
providing a solder paste printing tool with a movable solder paste cartridge, wherein the movable solder paste cartridge comprising:
a chamber with a front wall with a first angled bottom panel and a back wall with a second angled bottom panel, wherein the chamber contains a solder paste material;
a pushing member positioned between the front wall and the back wall of the chamber, wherein the pushing member comprising a first angled bottom surface and a second angled bottom surface;
providing a solder paste material into the chamber of the movable solder paste cartridge;
disposing a substrate with a stencil into the solder paste printing tool; and
conveying the movable solder paste cartridge over the substrate and dispensing the solder paste material by advancing the pushing member from an upper position to a lower position in the chamber to position the first and second angled bottom surfaces of the pushing member proximal to the first and second angled bottom panels of the chamber.

10. The method of claim 9, further comprising the first angled bottom panel of the chamber having a first lower edge and the second angled bottom panel of the chamber having a second lower edge; and
moving the dispensed solder paste material over the stencil and substrate using the first and second lower edges, respectively, of the first and second angled bottom panels of the chamber.

11. The method of claim 10, wherein the first angled bottom panel and the second angled bottom panel of the chamber are disposed at angles of approximately 45 degrees from a bottom horizontal.

12. The method of claim 9, wherein the movable solder paste cartridge is able to dispense approximately 85 percent of the solder paste material onto the substrate.

13. The method of claim 9, further comprising the front wall of the chamber having a plurality of inlets; and
providing a solder paste material into the chamber by introducing the solder paste material into the plurality of inlets in a sequential order.

14. A solder paste printing tool comprising:
a movable solder paste cartridge comprising:
an unpartitioned chamber comprising a front wall with a first angled bottom panel and a back wall with a second angled bottom panel, wherein the chamber contains a solder paste material;
a pushing member positioned between the front wall and the back wall of the chamber, the pushing member comprising a first angled bottom surface and a second angled bottom surface, and
wherein the pushing member moves from an upper position to a lower position in the chamber and disposes the first and second angled bottom surfaces of the pushing member proximal to the first and second angled bottom panels of the chamber; and
wherein the movable solder paste cartridge travels across a surface of a substrate to dispense the solder paste material onto the substrate.

15. The solder paste printing tool of claim 14, wherein the first and second angled bottom surfaces of the pushing member have shapes that are complimentary with the first and second angled bottom panels of the chamber.

16. The solder paste printing tool of claim 15 wherein the first angled bottom panel and the second angled bottom panel of the chamber are disposed at angles of approximately 45 degrees from a bottom horizontal.

17. The solder paste printing tool of claim 15, wherein the first angled bottom surface and the second angled bottom surface of the pushing member are disposed at angles of approximately 45 degrees from a bottom horizontal.

18. The solder paste printing tool of claim 14, further comprising the first angled bottom panel of the chamber having a first lower edge and the second angled bottom panel of the chamber having a second lower edge, wherein an aperture is formed between the first lower edge of the first angled bottom panel and the second lower edge of the second angled bottom panel.

19. The solder paste printing tool of claim 18, wherein the aperture has a width of approximately 26 mm.

20. The solder paste printing tool of claim 14, wherein the movable solder paste cartridge is able to dispense approximately 85 percent of the solder paste material onto the substrate.
